(19) United States
(12) Patent Application Publication
(10) Pub. No.: US 2011/0234176 A1
(43) Pub. Date: Sep. 29, 2011

(54) DISCHARGE CONTROL APPARATUS

(75) Inventors: Yasushi NAKAMURA, Nishio (JP); Kazuo AOKI, Anjo (JP)

(73) Assignee: AISIN AW CO., LTD., Anjo-shi (JP)

(21) Appl. No.: 13/015,098

(22) Filed: Jan. 27, 2011

(30) Foreign Application Priority Data
Mar. 24, 2010 (JP) 2010-068757

(51) Int. Cl. H02J 7/04

(52) U.S. Cl. 320/166

(57) ABSTRACT

A discharge control apparatus for discharging a residual charge that accumulates in a smoothing capacitor interposed between a direct current main power supply and an inverter, which performs a voltage conversion between a direct current power and an alternating current power, and remains in the smoothing capacitor when a connection between the inverter and the main power supply is cut, the discharge control apparatus. The discharge control apparatus having a backup power supply and a discharge control unit that is provided independently of a driver circuit for applying a switching control signal to a switching element constituting the inverter in order to operate the switching element in a saturation region, and that generates a discharge control signal for operating the switching element in an active region and applies the generated discharge control signal to the switching element.

### INCORPORATION BY REFERENCE

The disclosure of Japanese Patent Application No. 2010-068757 filed on Mar. 24, 2010 including the specification, drawings and abstract is incorporated herein by reference in its entirety.

### BACKGROUND OF THE INVENTION

The present invention relates to a discharge control apparatus for discharging a residual charge that accumulates in a smoothing capacitor interposed between an inverter and a direct current main power supply and remains in the smoothing capacitor when a connection between the inverter and the main power supply is cut.

### DESCRIPTION OF THE RELATED ART

In an electric automobile driven by a rotating electric machine or a hybrid automobile driven by an internal combustion engine and a rotating electric machine, the rotating electric machine functioning as a motor is driven by converting direct current power supplied from a battery into alternating current power using an inverter. When the rotating electric machine functions as a generator, alternating current power generated by the rotating electric machine is converted into direct current power by the inverter and used to regenerate the battery. A capacitor for smoothing the direct current power is provided between the battery and the inverter to suppress variation in the direct current power such as pulsation. The battery and the inverter are electrically connected when a main switch such as an ignition switch is turned ON, and as a result, the smoothing capacitor is charged. During regeneration, an electromotive force based on a charge charged to the smoothing capacitor via the inverter is supplied to the battery to charge the battery. When the main switch is turned OFF, the electric connection between the battery and the smoothing capacitor is cut, but the charged charge remains in the smoothing capacitor. The residual charge decreases through natural discharge, but natural discharge takes time. In certain cases, the main switch may be turned OFF and an inspection, maintenance, or the like performed immediately thereafter, and it is therefore preferable to discharge the residual charge of the smoothing capacitor more quickly than through natural discharge.

Japanese Patent Application Publication JP-A-H9-201065 (from the 8th to 20th paragraphs and FIGS. 1 and 2) discloses a power supply circuit that discharges a residual charge by operating a switching element constituting an inverter in an active region when a main switch is OFF such that a current controlled to a predetermined value is caused to flow. More specifically, a control device that adjusts a gate voltage of the switching element in order to operate the switching element in the active region is provided. The control device adjusts the gate voltage by switching a resistor connected in series to a control line, which is connected to a gate terminal of the switching element, thereby modifying a resistance value of the control line.

### SUMMARY OF THE INVENTION

The control device according to Japanese Patent Application Publication JP-A-H9-201065 must be operated when the main switch is OFF, and it is therefore to be understood that a supply of firm power is received from the battery of the vehicle regardless of the state of the main switch. This firm power constitutes so-called standby power, and therefore the overall standby power of the vehicle increases, leading to an increase in a battery load. Further, the control device according to Japanese Patent Application Publication JP-A-H9-201065 applies a gate control signal to the switching element using an identical driver circuit during both a discharge operation and a normal operation. Therefore, when a defect occurs in the control device, leading to a problem in control of the inverter such that the main switch is turned OFF, it may be impossible to discharge the residual charge of the smoothing capacitor swiftly.

It is therefore desirable to discharge a residual charge in a smoothing capacitor provided in a direct current power supply of an inverter via a switching element of the inverter quickly without causing an increase in standby power when a main switch is OFF.

In consideration of the problem described above, a characteristic constitution of a discharge control apparatus according to a first aspect of the present invention is a discharge control apparatus for discharging a residual charge that accumulates in a smoothing capacitor interposed between a direct current main power supply and an inverter, which performs a voltage conversion between a direct current power and an alternating current power, and remains in the smoothing capacitor when a connection between the inverter and the main power supply is cut. The discharge control apparatus includes: a backup power supply that supplies a power by which the discharge control apparatus is operable at least throughout a discharge period in which the residual charge is discharged, regardless of whether or not power is being supplied from the main power supply; and a discharge control unit that is provided independently of a driver circuit for applying a switching control signal to a switching element constituting the inverter in order to operate the switching element in a saturation region, and that generates a discharge control signal for operating the switching element in an active region and applies the generated discharge control signal to the switching element.

According to the first aspect, the backup power supply is provided, and therefore the standby power does not increase. Further, the residual charge in the smoothing capacitor can be discharged quickly when the main switch is OFF. Furthermore, the discharge control unit that generates the discharge control signal for operating the switching element constituting the inverter in the active region and applies the generated discharge control signal to the switching element is provided independently of the driver circuit for applying the switching control signal when the inverter operates normally, and therefore the residual charge in the smoothing capacitor of the inverter can be discharged via the switching element of the inverter quickly, for example, even when a defect occurs in the control apparatus, and thus control of the inverter becomes difficult and the main switch turns OFF.

Here, the discharge control apparatus according to a second aspect of the present invention may further include an interference prevention unit that prevents interference between the switching control signal and the discharge control signal. The switching control signal and the discharge control signal are both input into a control terminal (a gate or a base) of the switching element. Further, the driver circuit that applies the switching control signal to the switching element is constituted independently of the discharge control unit that applies the discharge control signal to the switching element. Therefore, by providing the interference prevention unit that prevents interference between the switching control signal and the discharge control signal and in particular permits application of the switching control signal by the driver circuit during a normal operation, an improvement in reliability is achieved.

The discharge control apparatus according to a third aspect of the present invention may further include a voltage reduction detection unit that detects a voltage reduction in a driver power supply that supplies an operating power to the driver circuit, wherein when a voltage of the driver power supply falls below a predetermined discharge start voltage, the discharge control unit generates the discharge control signal and applies the generated discharge control signal to the switching element. The discharge control unit preferably discharges the residual charge quickly when the inverter stops operating normally, or in other words when the switching element is no longer controlled via the driver circuit. If an operation of the discharge control unit is determined simply according to the presence of the switching control signal, the discharge control unit may be operated during a simple pause in the control. The driver circuit operates upon reception of the driver power supply. Therefore, when the voltage of the driver power supply decreases, it may be determined that the inverter is no longer operating normally and the switching element is no longer being controlled via the driver circuit due to disconnection of the main switch or the like, rather than a simple pause in the control. In other words, by monitoring the voltage of the driver power supply, it can be determined quickly and favorably that the inverter is no longer operating normally and that discharge of the smoothing capacity is required. According to this constitution, the discharge control apparatus includes the voltage reduction detection unit, and therefore the discharge control unit can start the discharge control quickly on the basis of the detection result obtained by the voltage reduction detection unit.

The discharge control apparatus according to a fourth aspect of the present invention may further include a current detection unit that detects a magnitude of a current that flows through the switching element as the residual charge is discharged, wherein the switching element includes a current sensing terminal that outputs a minute current which is smaller than and proportionate to the current flowing through the switching element, the current detection unit detects the magnitude of the current flowing through the switching element on the basis of the minute current, and the discharge control unit feedback-controls the discharge control signal on the basis of a detection result obtained by the current detection unit. Individual differences may exist in the characteristics of the switching element due to a manufacturing process, a packaging condition, and so on. When the switching element is used in the saturation region, these individual differences can be substantially absorbed by applying a switching control signal having a signal level margin. In the active region, on the other hand, an output reacts sensitively to the signal level of the control signal. The output in this case is the current passed through the switching element in order to discharge the residual charge, and when the value of the current is too large, the lifespan of the switching element is affected. Hence, the current detection unit is preferably provided to detect the current flowing through the switching element so that the discharge control unit can feedback-control the discharge control signal on the basis of the detection result. Furthermore, the switching element may include a current sensing terminal, and therefore, by forming the current detection unit using a signal output from this terminal, the current detection unit can be formed with a small-scale constitution.

### BRIEF DESCRIPTION OF THE DRAWINGS

FIG. 1 is a schematic block diagram showing an example of a motor driving circuit;

FIG. 2 is a power system diagram;

FIG. 3 is a schematic waveform diagram showing a waveform of a switching control signal;

FIG. 4 is a schematic block diagram showing a first leg of an inverter including a discharge control apparatus; and

FIG. 5 is a schematic circuit diagram showing a constitutional example of the discharge control apparatus.

### DETAILED DESCRIPTION OF THE EMBODIMENT

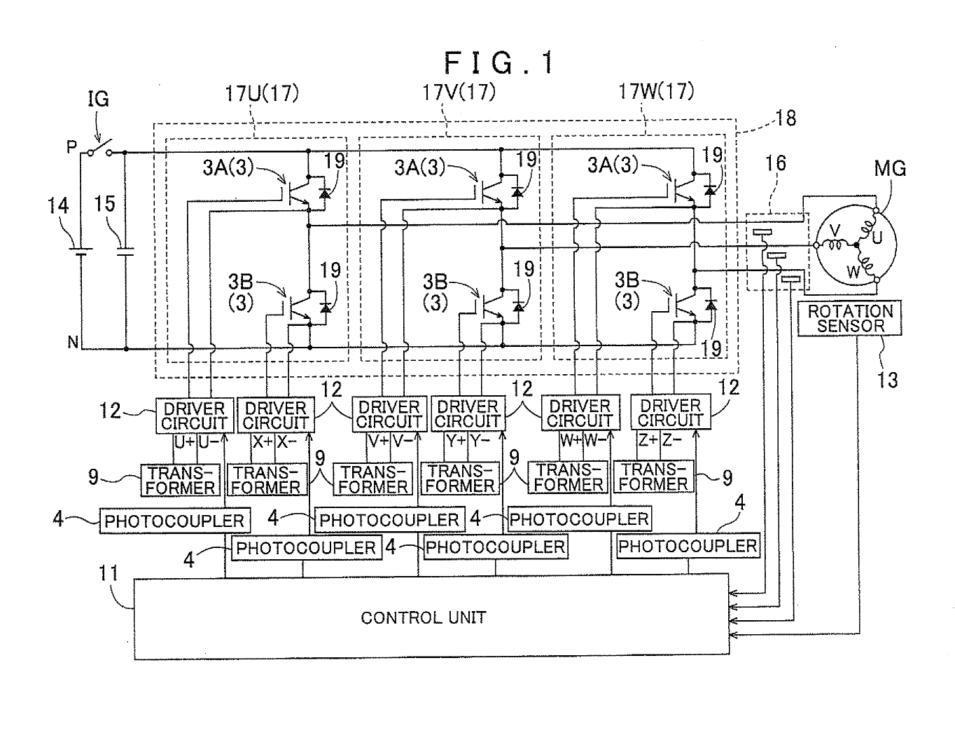

An embodiment of a case in which the present invention is applied to a motor driving circuit of an electric automobile or a hybrid automobile will be described below on the basis of the drawings. FIG. 1 shows a motor driving circuit to which a discharge control circuit according to the present invention is applied. In the interests of visibility, the discharge control circuit according to the present invention is not shown in FIG. 1. Note that a motor (rotating electric machine) MG naturally also functions as a generator. As shown in FIG. 1, a motor driving apparatus includes an inverter 18 that performs power conversion between direct current power and alternating current power, a direct current main battery (main power supply) 14, and a smoothing capacitor 15 interposed between the inverter 18 and the main battery 14 to smooth the direct current power. The main battery 14 is a chargeable secondary battery that supplies direct current power to the inverter 18 during a power running operation of the motor MG, and receives and stores direct current power from the inverter 18 during a regeneration operation of the motor MG. The inverter 18 converts the direct current power into alternating current power in order to supply three-phase alternating current power to the motor MG, which is constituted by a three-phase alternating current motor.

The inverter 18 includes a plurality of switching elements. An IGBT (insulated gate bipolar transistor) or a MOSFET (metal oxide semiconductor field effect transistor) may be applied favorably to the switching elements. As shown in FIG. 1, in this embodiment, IGBTs 3 are used as the switching elements. The inverter 18 includes a U phase leg 17U, a V phase leg 17V, and a W phase leg 17W corresponding respectively to the phases (three phases, namely a U phase, a V phase, and a W phase) of the motor MG. Each leg 17 (17U, 17V, 17W) includes a group of two switching elements constituted respectively by an IGBT 3A of an upper side arm and an IGBT 3B of a lower side arm, which are respectively connected in series. A fly wheel diode 19 IGBTs 3A, 3B is connected to each IGBT 3A, 3B in parallel therewith.

The U phase leg 17U, the V phase leg 17V, and the W phase leg 17W are connected to a U phase coil, a V phase coil, and a W phase coil of the motor MG. At this time, electrical connections are formed between an emitter of the IGBT 3A of the upper side arm and a collector of the IGBT 3B of the lower side arm in the legs 17U, 17V, 17W of the respective phases, and also with the coils of the respective phases of the motor MG. Further, a collector of the IGBT 3A of the upper side arm of each leg 17 is connected to a high voltage power supply line P connected to a positive electrode terminal of the main battery 14, and an emitter of the IGBT 3B of the lower side arm of each leg 17 is connected to a high voltage ground line N connected to a negative electrode terminal of the main battery 14.

The inverter 18 is connected to a control unit 11 via a photocoupler 4 and a driver circuit 12, and the respective IGBTs 3A, 3B of the inverter 18 perform switching operations in accordance with control signals generated by the control unit 11. Roles of the photocoupler 4 and the driver circuit 12 will be described below. The control unit 11 is constituted by an ECU (electronic control unit) having a logic circuit such as a microcomputer, not shown in the drawing, as a nucleus. The ECU includes, in addition to the microcomputer, an interface circuit, other peripheral circuits, and so on, not shown in the drawing.

The motor MG is driven at a predetermined output torque and a predetermined rotation speed by controlling the control unit 11. At this time, a value of a current passed through a stator coil of the motor MG is fed back to the control unit 11. Accordingly, a current value passed through a conductor (a bus bar or the like) provided between the legs 17U, 17V, 17W of the respective phases of the inverter 18 and the coils of the respective phases of the motor MG is detected by a current detection device 16 employing a Hall IC or the like. Further, a rotary angle of a rotor of the motor MG is detected by a rotation sensor 13 such as a resolver, for example, and transmitted to the control unit 11. On the basis of the detection results from the current detection device 16 and the rotation sensor 13, the control unit 11 drive-controls the motor MG by executing PI control (proportional integral control) and PID control (proportional integral derivative control) in accordance with a deviation from a target current. FIG. 1 shows an example in which the current detection device 16 is disposed for all of the three phases, but since the currents of the three phases are balanced and have an instantaneous value of zero, it is possible to detect only the current values of two phases.

In a case where the motor MG is a vehicle driving apparatus, as in this embodiment, or the like, the main battery 14 has a high voltage between 200 and 300V, and the respective IGBTs 3A, 3B of the inverter 18 switch high voltages. Meanwhile, the control unit 11 having a logic circuit such as a microcomputer as a nucleus is an electronic circuit that typically operates at a low voltage, for example a rated voltage of no more than approximately 12V and in many cases between approximately 3.3 and 5V. When compared with a common ground level, a potential of a pulse-shaped gate drive signal (switching control signal) input into a gate of the IGBT to be subjected to high voltage switching takes a significantly higher voltage than an operating voltage of a typical electronic circuit such as a microcomputer. Hence, the gate drive signal is voltage-converted and insulated via the photocoupler 4 and the driver circuit 12 and then input into the respective IGBTs 3A, 313 of the inverter 18.

The photocoupler 4 functions as an isolator to transmit the gate drive signal from the control unit 11 to the driver circuit 12 through optical transmission. When the gate drive signal is transmitted via the photocoupler 4, the control unit 11 and the driver circuit 12 are electrically insulated even while exchanging the gate drive signal. The driver circuit 12 voltage-converts the gate drive signal received through optical transmission to a signal having a predetermined voltage width, and then supplies the voltage-converted signal to the respective IGBTs 3 as a switching control signal.

The IGBTs 3 are turned ON when a predetermined voltage, in this embodiment a voltage of approximately 15V, is applied between the gate and the emitter. Each IGBT 3 is turned ON simply when a predetermined potential is generated between the gate and the emitter, regardless of a power supply voltage P-N of an inverter circuit 2, or in other words regardless of the potential of the emitter and collector of the IGBT 3, which uses a negative electrode N of the main battery 14 as a reference (ground level). The driver circuit 12 drives the gate drive signal from the control unit 11 to the inverter electrically independently of a power supply of the inverter 18, without setting the negative electrode N of the main battery 14 as a common reference (ground level). Therefore, in this embodiment, six driver circuits 12 are provided in accordance with the IGBTs 3 of the inverter 18.

The driver circuit 12 is an independent circuit (on the upper side arm in particular) that does not always share a ground level with the inverter 18. Hence, a power supply (a drive power supply) for operating the driver circuit 12 is also independent of the inverter 18. More specifically, the driver power supply is generated by a transformer 9 serving as a floating power supply. The plurality of driver circuits 12 are electrically independent of each other, and therefore a power supply is supplied to the respective driver circuits 12 from six transformers 9 having at least mutually independent outputs. In other words, each driver circuit 12 is driven by a floating power supply employing the transformer 9. The driver power supply supplied from the transformer 9 has a positive electrode T+ and a negative electrode T−. The respective power supplies from the six transformers 9 are expressed individually as follows, where a high side and a low side of each leg of the U, V and W phases are U, V, W and X, Y, Z, respectively (see FIGS. 1 and 3).

T+: U+, V+, W+, X+, Y+, Z+

T−: U−, V−, W−, X−, Y−, Z−

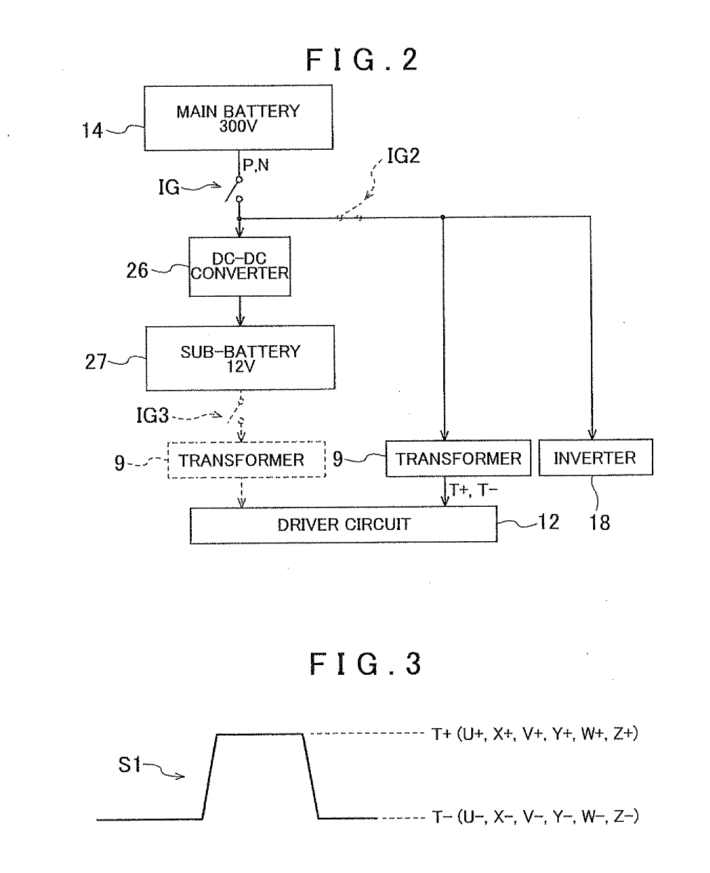

Using a power system diagram shown in FIG. 2, a power supply system will be summarized. The main battery (main power supply) 14 is a power supply for driving the motor MG (the inverter 18), and is constituted here by a direct current power supply having a rated voltage of 300V. As shown in FIGS. 1 and 2, the inverter 18 is connected to the main battery 14 via a main switch IG that operates in conjunction with an ignition switch of the vehicle. Further, a DC-DC converter 26 is connected to the main battery 14 via the main switch IG A reduced direct current voltage is stored in a sub-battery 27 having a rated voltage of 12V, for example, by the DC-DC converter 26. The sub-battery 27 supplies power to the control unit 11 and other in-vehicle equipment (an air-conditioner, an oil pump, and so on, known collectively as accessories).

The transformer 9 receives a primary side voltage from the sub-battery 27 or the main battery 14 and outputs a predetermined voltage between the positive electrode T+ and the negative electrode T− as a secondary side voltage via a rectifier circuit. Note that the vehicle also includes devices to which a small amount of power must be supplied constantly, such as a memory for storing current positions of, for example, an electric door, an electric seat, and a power window, a clock, and so on. Accordingly, there is no need to set a single main switch 1G directly below the main battery 14, as indicated by a solid line in FIG. 2, and instead, a plurality of switches IG2, IG3, and so on that operate in conjunction with the ignition switch may be set in a plurality of locations, as indicated by broken lines. Note that when the connection between the main battery 14 and the inverter 18 is cut, the driver circuit 12 does not have to be operated, and therefore the power supply to the transformer 9 is also cut.

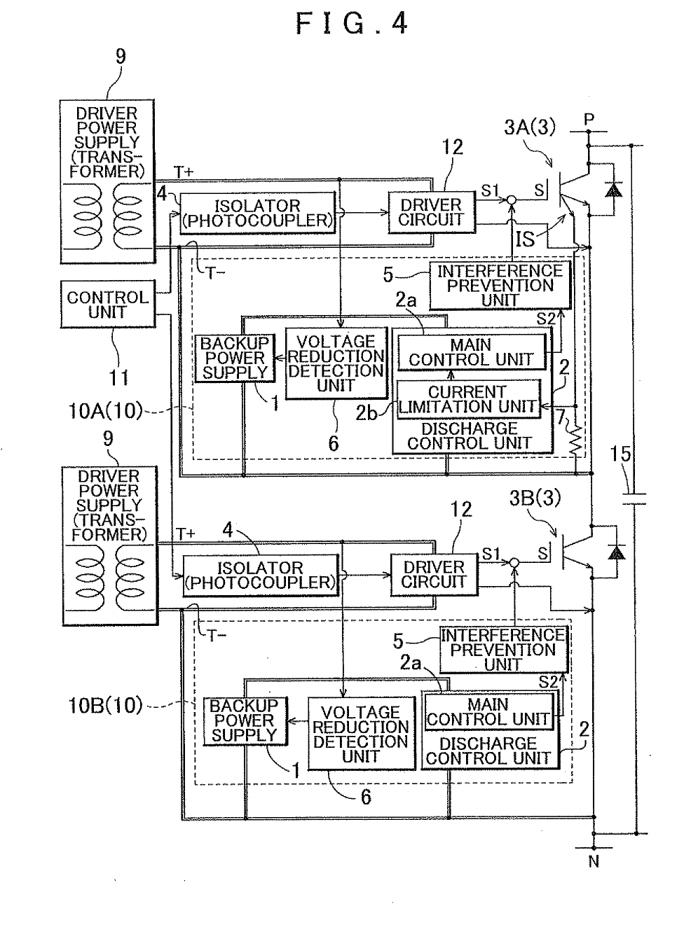

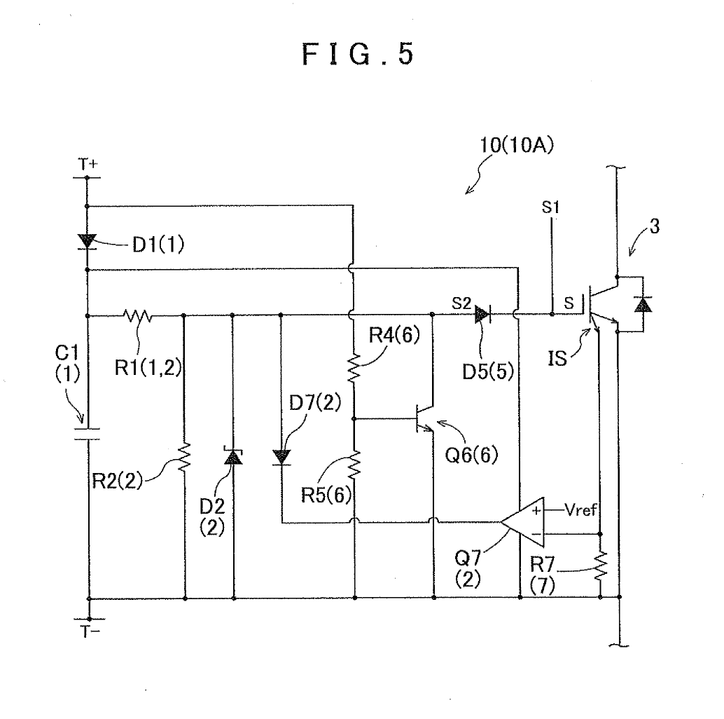

When the main switch IG is disconnected, the electric connection between the main battery 14 and the smoothing capacitor 15 is also cut, but a charge remains in the smoothing capacitor 15. Therefore, when the main switch 1G is OFF, the discharge control apparatus operates the IGSTs 3 (switching elements) provided in the inverter 18 in an active region such that a current controlled to a predetermined value is caused to flow, and thereby discharges the residual charge in the smoothing capacitor 15. The discharge control apparatus 10 will be described in detail below using a schematic block diagram showing one leg 17 of the inverter 18 including the discharge control apparatus 10 (FIG. 4) and a schematic circuit diagram showing an example of a discharge control circuit 10A provided in the discharge control apparatus 10 (FIG. 5). Note that in FIG. 4, double lines denote power system lines.

The discharge control apparatus 10 may be provided in only one of the three legs 17, but when the discharge control apparatus 10 is provided in a plurality of the legs 17, the smoothing capacitor 15 can be discharged in parallel, which is preferable. The respective legs 17 are constituted identically, and therefore a single leg 17 will be described as a representative example. Further, the discharge control apparatus 10 includes a first discharge control circuit 10A provided in the IGBT 3A of the upper side arm and a second discharge control circuit 10B provided in the IGBT 3B of the lower side arm. In other words, the smoothing capacitor 15 is discharged using the leg 17 of one phase by energizing both the IGBT 3A of the upper side arm and the IGBT 3B of the lower side arm. The first discharge control circuit 10A and the second discharge control circuit 10B may have completely identical constitutions, but in this embodiment, the first and second discharge control circuits 10A, 10B are constituted slightly differently. The first discharge control circuit 10A will be described below while indicating differences between the two where appropriate.

As shown in FIG. 4, the first discharge control circuit 10A (discharge control apparatus 10) includes a backup power supply 1, a discharge control unit 2, an interference prevention unit 5, a voltage reduction detection unit 6, and a current detection unit 7. The discharge control unit 2 controls the current passed through an IGBT 3 (switching element) to a predetermined value in order to operate the IGBT 3 in the active region such that the smoothing capacitor 15 is discharged.

The backup power supply 1 supplies power enabling the first discharge control circuit 10A (discharge control apparatus 10) to operate at least throughout a discharge period in which the residual charge of the smoothing capacitor 15 is discharged, regardless of whether or not power is being supplied from the main battery 14 serving as the main power supply. Here, an electrostatic capacity of the capacitor decreases at C₀e^{-t/τ} (where C₀: initial value of electrostatic capacity, e: Euler's number, T: time constant, and t: time). Strictly speaking, therefore, the discharge time for setting the residual charge in the smoothing capacitor 15 at zero is infinite. Hence, for practical purposes, a period in which the residual charge can be made negligible (a multiple of the time constant t, for example between approximately two and five times the time constant t) is set as the discharge period.

In this embodiment, as shown in FIG. 5, the backup power supply 1 is constituted by a capacitor C1 that is charged by the driver power supply 9 during a normal operation. A diode D1 connected such that a direction extending from the positive electrode (T+) of the driver power supply 9 toward the capacitor C1 is a forward direction serves as a backflow preventing diode. More specifically, the diode D1 permits charging of the capacitor C1 by the driver power supply 9 during a normal operation, and when the main switch 1G is disconnected such that the voltage of the driver power supply 9 decreases, the diode D1 blocks a current path from the capacitor C1 to the driver power supply 9. Accordingly, the diode D1 also forms a backup power supply. Note that the backup power supply 1 need not be limited to the embodiment described above in which the capacitor C1 is employed, and a secondary battery or a battery that generates power through a chemical reaction may be provided as the backup power supply 1.

The discharge control unit 2 generates a discharge control signal S2 for operating the IGBTs (switching elements) 3 constituting the inverter 18 in the active region and applies the generated discharge control signal S2 to the IGBT 3. In the first discharge control circuit 10A, the discharge control unit 2 includes a main control unit 2a and a current limitation unit 2b. As described above, during a normal operation of the inverter 18, a switching control signal S1 for operating the IGBT 3 in a saturation region is applied thereto via the driver circuit 12. As shown in FIG. 4, the discharge control unit 2 is provided completely independently of the driver circuit 12. Further, the interference prevention unit 5 for preventing interference between the switch control signal S1 and the discharge control signal S2 is provided, and therefore the discharge control signal S2 does not affect the IGBT 3 during a normal operation of the inverter 18. In other words, a gate control signal S constituted by either the switching control signal S1 or the discharge control signal S2 is applied to the IGBT 3.

The voltage reduction detection unit 6 detects a voltage reduction in the driver power supply 9 that supplies operating power to the driver circuit 12. When the voltage of the driver power supply 9 decreases due to disconnection of the main switch 1G or the like, the voltage reduction detection unit 6 detects the voltage reduction and operates the discharge control unit 2. In other words, the discharge control unit 2 generates the discharge control signal S2 and applies the signal S2 to the IGBT 3 when the voltage of the driver power supply 9 falls below a predetermined discharge start voltage.

The current detection unit 7 detects the magnitude of a current (collector-emitter current) flowing through the IGBT 3 during discharge of the residual charge in the smoothing capacitor 15. The discharge control unit 2 feedback-controls the discharge control signal S2 on the basis of the detection result obtained by the current detection unit 7. In this embodiment, a case in which the IGBT 3 includes a current sensing terminal IS that outputs a minute current which is smaller than and proportionate to the collector-emitter current will be described as an example. A minute current between 1/2000 and 1/10000, and preferably approximately 1/5000, of the collector-emitter current is output from the current sensing terminal IS. The current detection unit 7 detects the magnitude of the current flowing through the IGBT 3 by voltage-converting this minute current using a shunt resistor R7. Needless to say, the collector-emitter current may be detected directly using a current sensor or the like.

As shown in FIG. 4, the second discharge control circuit 10B is substantially identical to the first discharge control circuit 10A. In this embodiment, however, a case in which the second discharge control circuit 10B does not include the current detection unit 7 will be described as an example. When the collector-emitter current is controlled by controlling the IGBT 3 constituting one of the arms of a single leg 17 in the active region, a maximum value of the current flowing through the other IGBT 3 connected in series thereto is converged to the collector-emitter current. Therefore, when the IGBT 3 of one arm is controlled in the active region, the other arm may be controlled in the saturation region without problems. In this embodiment, discharge control is executed in a state where the collector-emitter current of the IGBT 3B on the lower side arm is larger than the collector-emitter current of the IGBT 3A on the upper side aim. Accordingly, an example in which the second discharge control circuit 10B provided in the IGBT 3B of the lower side arm does not include the current detection unit 7 is illustrated. Further, the IGBTs 3A and 3B are basically identical, and therefore the IGBT 3B also includes the current sensing terminal IS. In FIG. 4, the current sensing terminal IS of the IGBT 3B on the lower side arm is omitted.

However, the present invention is not limited to this constitution, and the first discharge control circuit 10A may be disposed on both arms. Whenever a defect occurs in current control by the first discharge control circuit 10A provided on one of the arms, current limitation is performed on the other arm, and therefore an overcurrent can be prevented from flowing to the IGBT 3. In other words, the first discharge control circuit 10A may be used on both arms as a failsafe mechanism. Needless to say, a constitution in which the second discharge control circuit 10B is provided on the upper side arm and the first discharge control circuit 10A is provided on the lower side arm may also be employed.

An operation of the first discharge control circuit 10A will be described below using the schematic circuit diagram shown in FIG. 5. As noted above, an operation of the second discharge control circuit 10B is basically identical. When the main switch IG is ON and a normal operation is underway in the inverter 18, a voltage between the positive electrode T+ and the negative electrode T− of the driver power supply 9 is higher than the discharge start voltage. Here, this voltage is set at 15V, for example. To facilitate understanding, specific numerical values will be cited hereafter where appropriate, but the present invention is not limited in any way to these numerical values. As shown in FIG. 3, the voltage between the positive electrode T+ and the negative electrode T− of the driver power supply 9 defines a low level and a high level of a pulse of the switching control signal S1 output to operate the IGBT 3 in the saturation region. In other words, a gate-emitter voltage at which the IGBT 3 sufficiently reaches the saturation region and which is included in a recommended operating range of the IGBT 3 is set as a positive-negative inter-electrode voltage of the driver power supply 9. The discharge start voltage is preferably set at a gate-emitter voltage close to a substantial lower limit at which the IGBT 3 operates in the saturation region. The value of this lower limit may be set at approximately 12V, for example. The discharge control circuit 10A is driven by the backup power supply 1, and therefore the discharge start voltage may of course be set at an even lower voltage, for example a voltage close to 0V.

Here, a transistor Q6 constituting the voltage reduction detection unit 6 turns ON when a base-emitter voltage is equal to or larger than 0.6V and turns OFF when the base-emitter voltage is smaller than 0.6V. When a partial pressure ratio between a resistor R4 and a resistor R5 is 57:3 and the positive-negative inter-electrode voltage of the driver power supply 9 is 12V, the base-emitter voltage of the transistor Q6 is 0.6V. When the positive-negative inter-electrode voltage of the driver power supply 9 is equal to or larger than 12V, the base-emitter voltage is equal to or greater than 0.6V, and therefore the transistor Q6 turns ON, whereby the discharge control signal S2 substantially takes the voltage value of the negative electrode T− of the driver power supply 9.

At this time, a diode D5 connected in a forward direction extending from the discharge control unit 2 toward a convergence point between the switching control signal S1 and the discharge control signal S2 functions as the interference prevention unit 5. A forward direction voltage of the diode D5 is between approximately 0.6 and 0.7V. Hence, as long as the voltage of the discharge control signal S2 on an anode terminal side of the diode D5 is not greater than the voltage value of the negative electrode T− by 0.7V or more, the diode D5 does not carry a current. When the transistor Q6 is ON, the voltage of the discharge control signal S2 on the anode terminal side of the diode D5 is substantially fixed at the voltage value of the negative electrode T− of the driver power supply 9, and therefore the diode D5 does not carry a current even if the switching control signal S1 is at the low level. Accordingly, as shown in FIG. 3, the switching control signal S1 can be output within the range of the positive-negative inter-electrode voltage of the driver power supply 9 without interfering with the discharge control signal S2.

Note that a resistor R1 functions as a resistance for performing charging using the driver power supply 9 without discharging a charge in the capacitor C1, which functions as the backup power supply 1 when the transistor Q6 is ON. In other words, when the resistor R1 is not provided, the voltages at the respective terminals of the capacitor C1 fall to zero via the transistor Q6 and are therefore not charged. Hence, the resistor R1 forms a part of the discharge control unit 2 and also functions as a part of the backup power supply 1.

Meanwhile, when the positive-negative inter-electrode voltage of the driver power supply 9 falls below 12V, the base-emitter voltage of the transistor Q6 falls below 0.6V, and therefore the transistor Q6 turns OFF. Strictly speaking, in certain cases the transistor Q6 does not turn completely OFF even when the base-emitter voltage thereof falls below 0.6V, but to facilitate description, it is assumed here that the transistor Q6 turns OFF. When the transistor Q6 turns OFF, the discharge control signal S2 as a general rule takes a voltage value corresponding to the voltage value of the positive electrode T+ of the driver power supply 9 or a voltage value of a positive electrode (the diode a1 side) of the capacitor C1 serving as the backup power supply 1, using the voltage value of the negative electrode T− of the driver power supply 9 as a reference. Here, the term “as a general rule” indicates that a maximum voltage value of the discharge control signal S2 is limited by a zener diode D2.

In this embodiment, a reverse breakdown voltage of the zener diode D2 is set at 9V. When the positive-negative inter-electrode voltage of the driver power supply 9 and the voltages at the respective terminals of the capacitor C1 exceed 9V, the voltage value of the discharge control signal S2 is limited to 9V by the zener diode D2 functioning as a voltage regulator. Meanwhile, when output from the driver power supply 9 is halted such that the voltages at the respective terminals of the capacitor C1 serving as the backup power supply 1 also fall below 9V, the discharge control signal S2 takes a voltage value corresponding to the voltages at the respective terminals of the capacitor C1.

As described above, the positive-negative inter-electrode voltage of the driver power supply 9 is set at a higher voltage than the gate-emitter voltage at which the IGBT 3 shifts from the active region to the saturation region. Therefore, the IGBT 3 may operate in the saturation region at a lower voltage (between 10 and 12V, for example) than the positive-negative inter-electrode voltage (15V, for example) of the driver power supply 9. Hence, an element having a reverse breakdown voltage that corresponds to a voltage-current characteristic of the gate-emitter voltage and the collector-emitter current of the IGBT 3 is preferably selected as the zener diode D2. In so doing, the discharge control signal S2 is generated as a signal for causing the IGBT 3 to operate in the active region without transiting the IGBT 3 to the saturation region.

Hence, in the discharge control unit 2, the zener diode D2 functions as a main control unit 2a for generating the discharge control signal S2 and a current limitation unit 2b for limiting the collector-emitter current of the IGBT 3. In other words, the zener diode D2 limits the collector-emitter current of the IGBT 3 by causing the IGBT 3 to operate in the active region without transiting the IGBT 3 to the saturation region.

Note that when the zener diode D2 functioning as the current limitation unit 2b is provided in the first discharge control circuit 10A, a similar zener diode D2 may be provided in the second discharge control circuit 10B. The reason for this is that when the collector-emitter current of one of the IGBTs 3 connected in series is limited, the collector-emitter current is held within a limited current value range even when the other IGBT operates in the saturation region. Alternatively, the zener diode D2 provided in the second discharge control circuit 10B may be an element having a higher reverse breakdown voltage than the zener diode D2 provided in the first discharge control circuit 10A.

In the first discharge control circuit 10A, the current limitation unit 2b is formed using not only the zener diode D2 but also an operational amplifier Q7. The operational amplifier Q7 may be an element that performs typical current intake and discharge operations. Further, a power supply voltage of the operational amplifier Q7 is supplied by the backup power supply 1, and therefore the operational amplifier Q7 preferably exhibits low power consumption, low-voltage driving, and low saturation.

The operational amplifier Q7 compares a voltage value representing the current value detected by the current detection unit 7 with a reference value Vref, and controls the collector-emitter current of the IGBT 3 by controlling the discharge control signal S2. When the collector-emitter current is large, voltages at the respective terminals of the shunt resistor R7 constituting the current detection unit 7 increase. For example, when the voltage is larger than the reference value Vref, an output of the operational amplifier Q7 is set at a low level (T− side). Accordingly, a current is taken into the operational amplifier Q7 via a diode D7, and therefore a voltage level of the discharge control signal S2 falls. As a result, the collector-emitter current of the IGBT 3 decreases, and feedback control based on the detection result of the current detection unit 7 is thus achieved. For example, the voltage level of the discharge control signal S2 is regulated within a range of approximately 7V to 9V. Meanwhile, when the voltages at the respective terminals of the shunt resistor R7 are smaller than the reference value Vref, the output of the operational amplifier Q7 is set at a high level (T+ side). Accordingly, the diode D7 does not carry a current, and as described above, the discharge control signal S2 is output at a voltage level dependent on the backup power supply 1 and the zener diode D2.

Note that a resistor R2 is a resistor (potential defining resistor) that guarantees the voltage value of the discharge control signal S2 when none of the “zener diode D2”, the “operational amplifier Q7 and diode D7”, and the “transistor Q6” are active, or in other words when none of these components contributes to setting of the voltage value of the discharge control signal S2. Although not a vital component, the resistor R2 constitutes a part of the discharge control unit 2.

Hence, the discharge control circuit 10A can be realized by a small-scale circuit formed from very inexpensive components. A person skilled in the art may be able to realize similar functions using different circuit configurations, but circuits having different configurations within a scope that does not depart from the spirit of the present invention belong to the technical scope of the present invention. The discharge control apparatus 10 is constructed within the power supply system of the drive circuit 12 for driving the respective IGBTs 3 and therefore exhibits favorable affinity with the drive circuit 12. Accordingly, the discharge control apparatus 10 also exhibits favorable affinity with the control signal (the switching control signal S1) output when the IGBTs 3 operate normally, and therefore favorable discharge control is achieved. Furthermore, although the discharge control apparatus 10 exhibits favorable affinity, it is constructed using a circuit that is completely independent of the drive circuit 12, and therefore, even when a defect or the like occurs in the control unit 11 or the drive circuit 12 such that the main switch IG turns OFF, the smoothing capacitor 15 can be discharged quickly.

As described above, according to the present invention, a residual charge in a smoothing capacity of an inverter can be discharged quickly via a switching element of the inverter without increasing a standby power when a main switch is OFF.

The present invention may be applied to a discharge control apparatus that discharged a residual charge that accumulates in a smoothing capacitor interposed between an inverter and a direct current main power supply and remains in the smoothing capacitor when a connection between the inverter and the main power supply is cut. The present invention can be applied particularly favorably to a discharge control apparatus provided in an electric automobile or a hybrid automobile installed with a rotating electric machine serving as a drive source and a regeneration source.

What is claimed is:

1. A discharge control apparatus for discharging a residual charge that accumulates in a smoothing capacitor interposed between a direct current main power supply and an inverter, which performs a voltage conversion between a direct current power and an alternating current power, and remains in the smoothing capacitor when a connection between the inverter and the main power supply is cut, the discharge control apparatus comprising:
a backup power supply that supplies a power by which the discharge control apparatus is operable at least throughout a discharge period in which the residual charge is discharged, regardless of whether or not power is being supplied from the main power supply; and
a discharge control unit that is provided independently of a driver circuit for applying a switching control signal to a switching element constituting the inverter in order to operate the switching element in a saturation region, and that generates a discharge control signal for operating the switching element in an active region and applies the generated discharge control signal to the switching element.

2. The discharge control apparatus according to claim 1, further comprising:
an interference prevention unit that prevents interference between the switching control signal and the discharge control signal.

3. The discharge control apparatus according to claim 2, further comprising:
a voltage reduction detection unit that detects a voltage reduction in a driver power supply that supplies an operating power to the driver circuit, wherein
when a voltage of the driver power supply falls below a predetermined discharge start voltage, the discharge control unit generates the discharge control signal and applies the generated discharge control signal to the switching element.

4. The discharge control apparatus according to claim 3, further comprising:
a current detection unit that detects a magnitude of a current that flows through the switching element as the residual charge is discharged, wherein
the switching element includes a current sensing terminal that outputs a minute current which is smaller than and proportionate to the current flowing through the switching element,
the current detection unit detects the magnitude of the current flowing through the switching element on the basis of the minute current, and
the discharge control unit feedback-controls the discharge control signal on the basis of a detection result obtained by the current detection unit.

5. The discharge control apparatus according to claim 1, further comprising:
a voltage reduction detection unit that detects a voltage reduction in a driver power supply that supplies an operating power to the driver circuit, wherein
when a voltage of the driver power supply falls below a predetermined discharge start voltage, the discharge control unit generates the discharge control signal and applies the generated discharge control signal to the switching element.

6. The discharge control apparatus according to claim 3, further comprising:
a current detection unit that detects a magnitude of a current that flows through the switching element as the residual charge is discharged, wherein
the switching element includes a current sensing terminal that outputs a minute current which is smaller than and proportionate to the current flowing through the switching element,
the current detection unit detects the magnitude of the current flowing through the switching element on the basis of the minute current, and
the discharge control unit feedback-controls the discharge control signal on the basis of a detection result obtained by the current detection unit.

7. The discharge control apparatus according to claim 1, further comprising:
a current detection unit that detects a magnitude of a current that flows through the switching element as the residual charge is discharged, wherein
the switching element includes a current sensing terminal that outputs a minute current which is smaller than and proportionate to the current flowing through the switching element,
the current detection unit detects the magnitude of the current flowing through the switching element on the basis of the minute current, and
the discharge control unit feedback-controls the discharge control signal on the basis of a detection result obtained by the current detection unit.

8. The discharge control apparatus according to claim 2, further comprising:
a current detection unit that detects a magnitude of a current that flows through the switching element as the residual charge is discharged, wherein
the switching element includes a current sensing terminal that outputs a minute current which is smaller than and proportionate to the current flowing through the switching element,
the current detection unit detects the magnitude of the current flowing through the switching element on the basis of the minute, current, and
the discharge control unit feedback-controls the discharge control signal on the basis of a detection result obtained by the current detection unit.
